(19) United States
(12) Patent Application Publication
(10) Pub. No.: US 2021/0207041 A1
(43) Pub. Date: Jul. 8, 2021

(54) Process for Hydrotreating a Diesel Fuel Feedstock with a Feedstock of Natural Occurring Oil(s), Hydrotreating Unit for the Implementation of the Said Process, and Corresponding Hydrorefining Unit

(71) Applicant: Total Research & Technology Feluy, Seneffe (BE)

(72) Inventors: Walter Vermeiren, Houthalen (BE); Cindy Adam, Wierde (BE)

(21) Appl. No.: 17/059,662

(22) PCT Filed: May 28, 2019
(86) PCT No.: PCT/EP2019/063756

§ 371 Date: Nov. 30, 2020

(30) Foreign Application Priority Data
May 30, 2018 (EP) 18175267.6

(51) Int. Cl. C10G 45/26; C10G 31/06; C10G 67/02

(52) U.S. Cl. CPC C10G 45/26; C10G 31/06; C10G 67/02; C10G 2300/1014; C10G 2300/4018; C10G 2300/104; C10G 2300/1055; C10G 2300/807; C10G 2400/04; C10G 2300/1018

(57) ABSTRACT

The invention relates a process for the catalytic hydrotreating of a feedstock of petroleum origin of diesel fuel type introduced into a stationary bed hydrotreating unit upstream of a feedstock of natural occurring oil(s) characterized in that the feedstock of natural occurring oil(s) contains acyl-containing compounds having 10 to 24 carbons including fatty acid esters and free fatty acids and said feedstock of natural occurring oil(s) is submitted to a refining by a hydrodynamic cavitation before its introduction into the stationary bed processing.

The invention relates to a process for hydrotreating a diesel fuel feedstock, to a hydrotreating unit for the implementation of the said process, and to a corresponding hydrorefining unit.

Due to the increasing stringency of pollution control standards for diesel engines, the specifications for diesel engine fuels have changed during the last two decades and new constraints have appeared which have resulted in a modification of the formulations of diesel engine fuel mixtures.

Since March 2018, the specifications for diesel engine fuels have been as follows: (European Standard EN590):
Density (at 15° C.): 820-845 kg/m³
T95% (Distillation temperature for 95% of the diesel fuel): 360° C. (maximum)
Sulphur content: 10 mg/kg (maximum)
Engine octane number: 51 (minimum)
Calculated cetane index (ASTM D4737): 46 (minimum)
Cloud point: <−5° C. in winter,
   <+5° C. in summer.

The desired bases are thus light sulphur-free bases with a high cetane index which distil completely before 360° C.

One solution for improving the cetane index consists in adding a cetane number improver. These are generally alkyl nitrates, which intervene in the basic oxidation stages before the self-ignition of the mixture. They thus reduce the ignition delay and make it possible to increase the cetane index by 3 to 5 points, depending on the amount added. However, they decrease in effectiveness as the starting cetane index decreases.

Another solution consists in adding a substitute fuel to the mixture, such as a biofuel, as esters of vegetable oils generally exhibit a good cetane index.

For this reason, European Directive 2009/28/CE amended by European Directive (UE) 2015/1513 is targeted in particular at promoting the use of biofuels. In transportation, the European Community adopted an objective of 10% renewable energy in transport in 2020 (biofuels but also renewable electricity).

Currently, the French Government has introduced a tax; the TGAP (Taxe Générale des Activités Polluantes) [General Tax on Polluting Activities], which relates to fuels consumed on French territory. The fuels subject to this tax are “SP95”, “SP98” and “Diesel Engine Fuel”. The objective of this tax is to encourage the incorporation of biofuel 7.7% NCV (Net Caloric Value) for diesel and 7.5% NCV for gasoline in 2017.

This addition is carried out on the basis of the energy and the “bio” origin of the products incorporated. Thus, the level of ETBE (ethyl tert-butyl ether) is reduced since it comprises only 47% of ethanol (of agricultural origin) and a lower NCV than petrol.

For diesel engine fuels, the most commonly used biofuels are vegetable oil esters, such as rapeseed oil methyl ester (RME).

These diesel engine fuels are generally obtained by mixing the biofuel with the diesel engine fuel after treatment of the latter. These mixtures are thus often produced by the distributors, immediately before distributing the fuel.

The mixtures obtained from vegetable oil methyl esters exhibit the advantage of a cetane number in accordance with the standard but their density (greater than 880 kg/m³) is much greater than the specification of the standard, which causes formulation difficulties at high levels of incorporation. Vegetable oil esters also result in excessively heavy mixtures, without forgetting the problem of stability over time.

Processes for refining the biomass which have been developed for producing these biofuels are already known. Thus, the documents U.S. Pat. Nos. 4,992,605, 5,705,722, EP 1 396 531 and SE 520 633 describe processes for hydrotreating triglycerides present in vegetable oils. However, the reactions employed are highly exothermic. In order to limit the problems related to this high exothermicity, it is necessary to recycle up to 80% of the outlet of the hydrotreating reactor to the inlet of the latter, hence the need to built a new plant dedicated to this hydrotreating process and to hydraulically oversize this unit with respect to the amount of the feedstock actually treated.

Furthermore, Patent Application EP 1 693 432 describes a process for hydrotreating a mixture of a feedstock of petroleum origin and of a feedstock of biological origin. Nevertheless, as the reactions for the hydrodeoxygenating of the triglycerides are faster than those for the hydrorefining of the petroleum fractions, the treatment of such a mixture of feedstocks of petroleum and biological origin at the top of the reactor results in a drop in the hydrogen partial pressure and thus a drop in the catalytic activity in hydrotreating the petroleum feedstock. Furthermore, parallel reactions during the hydrorefining of the triglycerides result in the production of gases, such as carbon dioxide CO₂, methane CH₄ and carbon monoxide CO, which is regarded as a reversible inhibitor of the desulphurizing activity of the catalyst. In fact, in a conventional hydrotreating unit, these gases, which comprise hydrogen H₂ (recycle gas), are generally separated from the effluent exiting from the reactor and then reinjected into the reactor after passing through a treatment system. The presence of CO in the recycle gas thus proves to be unfavourable to the reactions for the hydrorefining of the petroleum fraction.

The Applicant Company has proposed, in its French Patent Application 06.11028, a process for the catalytic hydrotreating of a feedstock of petroleum origin of diesel fuel type and of a feedstock of biological origin in a stationary bed catalytic hydrotreating unit, the said process being characterized in that the feedstock of petroleum origin is introduced into the said reactor upstream of the feestock of biological origin.

A diesel engine fuel which contains a part of biological origin, also called bio-distillate or bio-diesel, is an alternative fuel for diesel engines becoming increasingly important.

In addition to meeting engine performance and emissions criteria/specifications, bio-distillates have to compete economically with diesel engine fuel and should not compete with food applications for the same triglycerides. Vegetable oils partially or fully refined and of edible-grade quality are currently predominant feedstocks for bio-distillate production. The prices of these oils are relatively high for fuel-grade commodities.

These considerations have led to efforts to identify less expensive materials that could serve as feedstock for bio-diesel production and to design chemical processes for their conversion. Thus, animal fats have been converted to bio-diesel [C. L, Peterson, D. L. Reece, B. L. Hammond, J. Thompson, S. M. Beck, “processing, characterization and performance of eight fuels from lipids”, Applied Engineering in Agriculture. Vol. 13(1), 71-79, 1997; F. Ma, L. D. Clements and M. A. Hanna, “The effect of catalyst, free fatty acids and water on transesterification of beef tallow”, Trans ASAE 41 (5) (1998), pp. 1261-1264], and substantial efforts have been devoted to the development of waste restaurant grease [M. Canakci and J. Van Gerpen, “Bio-distillates production from oils and fats with high free fatty acids”, Trans. ASAE 44 (2001), pp. 1429-1436; Y. Zhang, M. A. Dube, D. D. McLean and M. Kates, “Bio-distillates production from waste cooking oil. 1. Process design and technological assessment”, Bioresour, Technol. 89 (2003), pp. 1-16; W.-H. Wu, T. A. Foglia, W. N. Marmer, R. O. Dunn, C. E. Goering and T. E. Briggs, J. Am. Oil Chem. Sac, 75 (1998) (9), p, 1173], largely the spent product of the deep fat frying of foods, as a bio-diesel feedstock.

The industrial chemistry of fats & oils is a mature technology, with decades of experience and continuous improvements over current practices. Natural fats & oils, such as vegetable oils, animal fats, consist mainly of glycerides (mono-, di- but mainly tri-glycerides), and to some extent of free fatty acids (FFA). Many different types of triglycerides are produced in nature, either from vegetable as from animal origin. Most of acyl-moieties in fats & oils are found esterified to glycerol (triacylglycerol). The acyl-group is a long-chain (C₁₀-C₂₄) hydrocarbon with a carboxyl-group at the end that is generally esterified with glycerol. Fats & oils are characterized by the chemical composition and structure of its fatty acid moiety. The fatty acid moiety can be saturated or contain one or more double bonds. Bulk properties of fats &, oils are often specified as “saponification number”, “Iodine Value”.

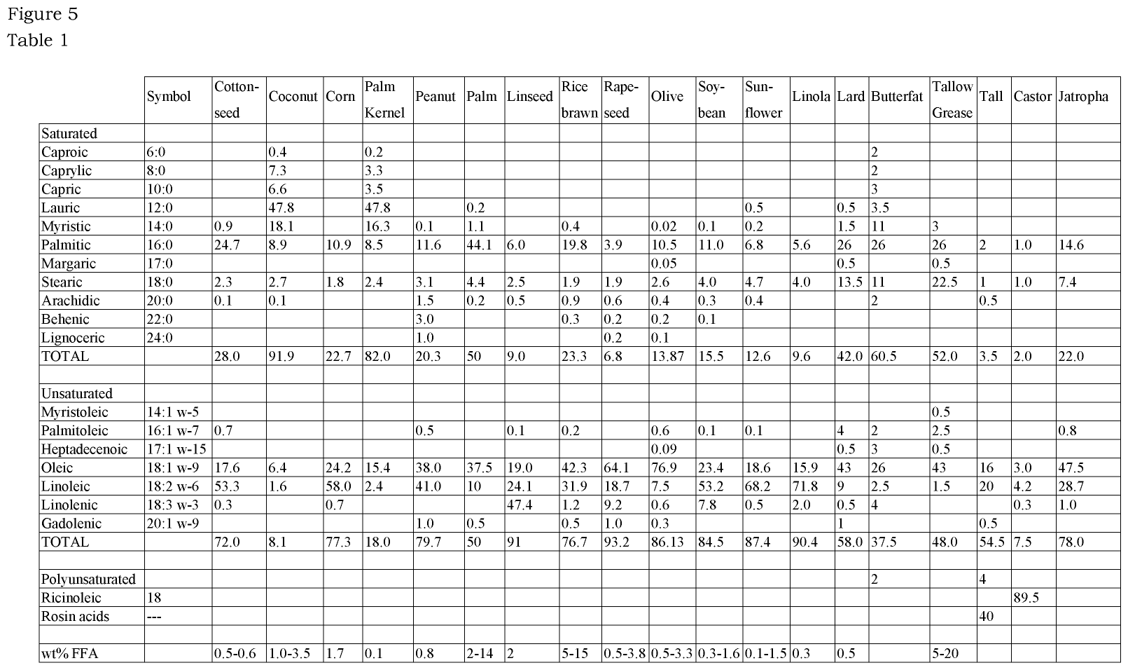

Some typical sources of fats & oils and respective composition in fatty acids (fatty acid esters or free fatty acids) are given by way of example in Table 1 (FIG. 5).

There are other potential feedstocks available at this time, namely trap and sewage grease and other very high free fatty acid greases in which the FFA's can exceed 50 wt %.

The main sources of fats & oils are palm and palm kernels, soybeans, rapeseed, sunflower, coconut, corn, animal fats, milk fats.

Potentially new sources of triglycerides will become available in the near future, namely those extracted from Jatropha and those produced by microalgues. These microalgues can accumulate more then 30 wt % of lipids on dry basis and they can either be cultivated in open basin, using atmospheric CO₂ or in closed photobioreactors. In, the latter case, the required CO₂ can originate from the use of fossil hydrocarbons that are captured and injected into the photobioreactor. Main sources of fossil. CO₂ are power stations, boilers used in refineries, fluided catalytic cracking (FCC) regenerators and steamcrackers furnaces used to bring hydrocarbon streams at high temperature or to supply heat of reactions in hydrocarbon transformations in refineries and steamcrackers. In particular steamcracking furnaces and the FCC regenerator produce a lot of CO₂.

Bio-diesel is currently produced by transesterification of triglycerides with methanol, producing methyl-ester and glycerol. This transesterification is catalysed by homogeneous or heterogeneous basic catalyst. Typically homogeneous catalysts are alkali hydroxides or alkali alkoxides and typical heterogeneous catalysts are alkaline earth or zinc oxide materials, like zinc or magnesium-aluminate spinels. The presence of free fatty acids (FFA) in the raw triglycerides is a cumbersome for the production of bio-diesel as the FFAs react stoechiometrically with the basic catalyst producing alkali or alkaline soaps.

In the context of the invention and in order to prevent fouling of the hydrotreating unit, the sources of fats & oils can't be used crude.

This means that fats oils, that contain significant amounts of FFA's, cannot be employed directly for bio-diesel production with this process. Several technical solutions have been proposed:
(i) starting with an acid catalysed interesterification with additional glycerol to convert FFA's into glycerides prior to the basic transesterification
(ii) prior to the basic catalysed transesterification the FFA's are removed by steam and/or vacuum distillation. The latter solution results in a net loss of feedstock for the production of bio-diesel, Eventually, the so produced FFA's can be converted by acid catalysis into esters in a separate process unit. FFA's can be present in fats and oils in different concentrations and can be present as such resulting from the extraction process or can be produced during storage as of the presence of trace amounts of lipase enzyme that catalyse the triglyceride hydrolysis or can be produced during processing, like thermal treatments during cooking.

US 2007/0175795 reports the contacting of a hydrocarbon and a triglyceride-containing compound to form a mixture and contacting the mixture with a hydrotreating catalyst in a fixed bed reactor under conditions sufficient to produce a reaction product containing diesel boiling range hydrocarbons. The example demonstrates that the hydrotreatment of such mixture increases the cloud point and pour point of the resulting hydrocarbon mixture.

US 2004/0230085 reports a process for producing a hydrocarbon component of biological origin, characterized in that the process comprises at least two steps, the first one of which is a deoxygenation step and the second one is an isomerisation step. A biological material containing fatty acids and/or fatty acid esters serves as the feedstock. The resulting products have low solidification points and high cetane number and can be used as diesel or as solvent.

US 2007/0135669 reports the manufacture of branched saturated hydrocarbons, characterized in that a feedstock comprising unsaturated fatty acids or fatty acids esters with C1-C5 alcohols, or mixture thereof, is subjected to a skeletal isomerisation step followed by deoxygenation step. The results demonstrate that very good cloud points can be obtained.

US 2007/0039241 reports on a process for cracking tallow into diesel fuel comprising: thermally cracking the tallow in a cracking vessel at a temperature of 260-371° C., at ambient pressure and in the absence of a catalyst to yield in part cracked hydrocarbons.

U.S. Pat. No. 4,554,397 reports on a process for manufacturing olefins, comprising contacting a carboxylic acid or a carboxylic ester with a catalyst at a temperature of 200-400° C., wherein the catalyst simultaneously contains nickel and at least one metal from the group consisting of tin, germanium and lead.

To be used in the above processes, as in many other processes, in particular for food uses, naturally occurring fats and oils have to be refined by well known chemical and physical processes. Crude oils and fats indeed contain phosphatides, waxes, pro-oxidants and other impurities that might lead to deposits of so-called gums on storage and transport. These gums are formed by hydratation of some of the phosphatides contained in the oils/fats.

Chemical refining for food-grade applications comprises a degumming step, a neutralisation step with an alkaline solution (usually NaOH) to remove the FFA's and the resulting soaps can be used as such or the soaps can be split to use the pure FFA's, a bleaching step and deodorisation. FFA's, most of the phosphatides, and other impurities are removed during chemical refining.

Physical refining comprises a degumming step, a bleaching step and a steam refining deodorisation step. Here, the phosphatides and other impurities are removed in the degumming step while FFA's are removed by distillation during deodorization step.

However, these well known processes consume chemicals, generate waste and may consume a lot of energy, in particular when heating is required. Moreover, if such a refining is necessary for food use, it may not be useful for other purposes, such as fuel production. Finally, these refining methods eliminate FFA's which may reduce the amount of fuel production. It is however necessary to remove phosphatides as well as metals from natural occurring oils and fats to use them in a fuel production process as these processes use solid catalysts and typically higher operating temperatures. Hence, all impurities that might result in solid catalyst deterioration or fouling of equipment due to deposition of certain impurities have to be removed. Due to the complexity of the oils, elimination of all gum products can be difficult. In particular the remaining amount of phosphatides and metals in the refined oils and fats in order to protect properly the catalytic deoxygenation process is generally more severe than for food applications. Moreover, as for food applications rarely mixtures of oils of different origins arc simultaneously processed, for fuel applications most of the time mixtures of oils and fats of different origins are used and their relative ratios over time might fluctuate a lot. So there is a need for a flexible and robust process to properly remove phosphatides and metals from complex mixtures of oils and fats of different origin and of fluctuating composition.

Crude fats & oils may may vary widely in potential gum content due to their content in phosphatides. Typical contents of phosphatides and phosphorus are given in table 2 extracted from conference paper: Andrew Logan, Degumming, Refining, and Water Washing of Oils in Lipids: From Fundamentals to the Future, Abu Dhabi, 15-16 Apr. 2008,

TABLE 2

| | Phosphatides | Phosphorus |
|---|---|---|
| Oil type | (wt %) | (wtppm) |
| Coconut | 0.02-0.05 | 10-20 |
| Corn | 0.7-2.0 | 250-800 |
| Cottonseed | 1.0-2.5 | 400-1000 |
| Groundnut | 0.3-0.7 | 100-300 |
| Palm | 0.03-0.1 | 15-30 |
| Rapeseed | 0.5-3.5 | 200-1400 |
| Soya | 1.0-3.0 | 400-1200 |
| Sunflower | 0.5-1.3 | 200-500 |

The chemical structure of most common phosphatides are provided below: phosphatidic acid (or PA), phosphatidylethanolamine (or PE), phosphatidylcholine (or PC) and phosphatidylinositol (or PI).

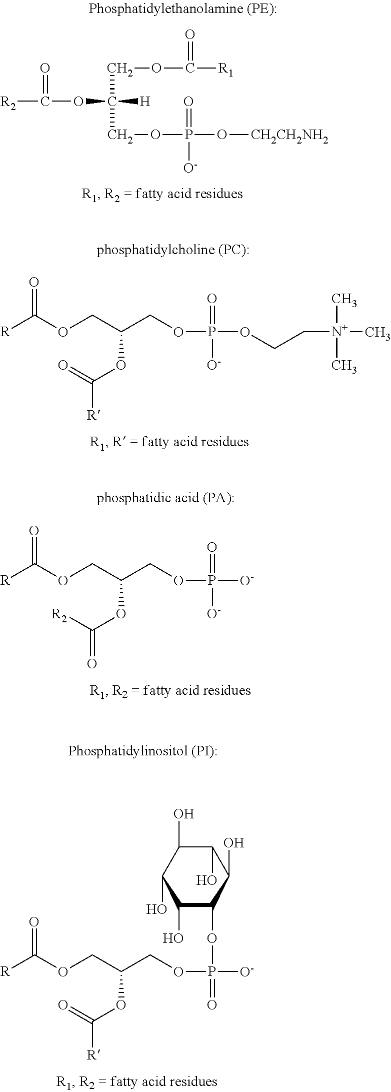

As these compounds are often charged because of the low (phosphate group) or high pKa (amino group) they can also contain alkali or alkaline earth elements or can take up metal cations as copper or iron (Albert J. Dijkstra, About water degumming and the hydration of non-hydratable Phosphatides, Eur. J. Lipid Sci. Technol. 2017, 119, 1600496).

Four major well known degumming processes are most commonly used and described thereafter.

One of them is water degumming which consists in mixing oil with water. The degree to which a phosphatide can be removed during water degumming depends on its hydrophilicity and hence is strongly influenced by the pH of the water used during degumming (see below table 3).

TABLE 3

| pH | PC | PE | PI | PA | Ca-PA |
|---|---|---|---|---|---|
| 2 | + | + | 0 | 0 | 0 |
| 3 | (+) | (+) | 0 | 0 | 0 |
| 4 | (±) | (±) | (−) | (−) | 0 |
| 5-7 | ± | ± | − | − | 0 |
| 8-9 | ± | ± | − | (2−) | 0 |
| >10 | ± | − | − | 2− | 0 |

Explanation: numbers between parentheses indicate a transition between the value at lower pH and the value at higher pH.
(+) About half the moieties have a positive charge
± Nearly all moieties are Zwitterions
(±) About half the moieties are Zwitterions
0 Hardly any moieties carry a charge
(−) About half the moieties carry a negative charge
− Nearly all moieties carry a single negative charge
2− Nearly all moieties carry a double negative charge

Phosphatidylinositol (PI), having five free hydroxyl groups on the inositol moiety makes PI strongly hydrophilic and will be hydrated during the water degumming treatment and the PI content of properly water-degummed oil is negligible. Similarly, the positive charge of the trimethylamino group in phosphatidylcholine (PC) makes this phosphatide hydrophilic. This hydrophilicity does not, depend on the pH of the water used to degum the oil since even at pH>5, when the phosphate group in the PC is dissociated and therefore carries a negative charge, it does not form an internal salt with the quaternary amino group for steric reasons. Consequently, the positive quaternary amino group remains isolated at all pH values and causes PC to be hydrophilic at all pH values. Almost all phosphatidylethanolamine (PE) molecules have a positive charge at pH=2 and hence hydrophilic and hydratable. When the pH is increased, more and more phosphate groups dissociate and so a zwitterion is formed in which the positive amino group forms an internal salt with the negative phosphate group and hence loses hydrophilicity and hydration of PE is incomplete (water-degummed oil still contains some PE).

In case of phosphatidic acid (PA), in an acid environment, the hydroxyl groups of its phosphate moiety will not dissociate since the pKₐ value of the first hydroxyl group equals 2.7-3.8. Consequently, PA will be poorly hydratable and remain in the oil when in contact with acid water. Raising the pH of this water to 5, dissociates most of the PA so that the molecule has a negative charge giving it a hydrophilicity that makes it hydratable.

The calcium salt of PA remain uncharged at all pH values because the divalent calcium forms a salt with the two dissociated, hydroxyl groups of the phosphate moiety and hence alkaline earth salts of PA remain in the oil when it is degummed with water and constitute the nonhydratable phosphatides (NHP).

Beside these thermodynamic considerations, ruled by chemical properties like pKa, the degumming process is also a kinetically controlled process, meaning that thermodynamic equilibrium is not always reached because of diffusion limitations of the phosphatides through the oil phase to the water interface but also because of the occurrence (concentration) of reacting species at the interface of oil-water. It is believed that for water degumming the dispersion is less essential but for reactive degumming where acids, complexing agents (like EDTA) or enzymes are used the dispersion of the aqueous phase in the oil phase is very important.

The main purposes of the water degumming process are to produce oil that does not deposit a residue during transportation and storage, and to control the phosphorus content of crude oils just below 200 wppm (typically 50-200 wppm). Only hydratable phosphatides are removed with this process. The nonhydratable phosphatides, which are calcium and magnesium salts of phosphatic acid and phosphatidyl ethanolamine, remain in the oil after water degumming.

In water degumming the oil is typically heated to 60-70° C., water added and mixed about 30 minutes followed by centrifugal separation of hydrated gums and vacuum drying of degummed oil. This process involves the addition of live steam to raw oil for a short period. The proper amount of water is normally about 75 wt % of the phosphatides content of the oil. Too little water produces dark viscous gurus and hazy oil, while too much water causes excess oil losses through hydrolysis. Water-degummed oil usually still contains phosphatides (between 50 and 200 wppm).

Acid degumming process is another major degumming process. It leads to lower residual phosphorus content (typically 20-50 wppm) than water degumming. The acid degumming process might be considered as a variant of the water degumming process in that it uses a combination of water and acid. The non-hydratable phosphatides can be conditioned into hydratable forms, with acid degumming although the action of the degumming acid does not lead to full hydration of the phosphatides. Phosphoric and citric acids are used because they are sufficiently strong and they bind divalent metal ions. Several acid degumming processes have been developed to attain a phosphorus value lower than 5 wppm that is required for good quality physically refined oils. In acid degumming the oil is heated to 60-70° C., acid added and mixed about 30 minutes.

Dry degumming process is another major degumming process in which the oil is treated with an acid (principle is that strong acids displace weaker acids from their salts) to decompose the metal ion/phosphatides complex and is then mixed with bleaching earth. The earth containing the degumming acid, phosphatides, pigments and other impurities is then removed by filtration. This process constitutes the main treatment for palm oil, lauric oils, canola oil and low phosphatides animal fats, such as tallow or lard.

The last major degumming process is enzymatic degumming process, in which an enzyme, for example Phospholipase A1, the latest developed degumming enzyme, changes the phospholipids into lysophospholipids and free fatty acids. This process has three important steps:
(1) adjustment of the pH with a buffer;
(2) enzymatic reaction in the holding tanks; and
(3) separation of the sludge from the oil.

Oil to be degummed enzymatically by this way can be crude or water degummed.

The lipid handbook (The lipid handbook, edited by Frank D. Gunstone, John L. Harwood, Albert J, Dijkstra, 3rd ed.) describes many variants and details of the degumming processes.

All these degumming processes may not allow sufficient removal of some compounds such as phosphatides, metals to allow a direct use in a hydroprocessing process.

There is therefore a need for an efficient degumming process allowing production of refined oil suitable for fuel production. Moreover, there is a need for a flexible and robust process to properly remove phosphatides and metals from complex mixtures of oils and fats of different origin and of fluctuating composition.

Moreover, peroxides are produced by the action of oxygen, ozone, H₂O₂ or other inorganic or organic peroxides on unsaturations of fatty acid chains or esters. Such peroxides are also responsible for the formation of gum as well as phosphatides. These peroxides can pass through the conventional degumming treatments and end up in the hydroprocessing unit, There is therefore also a need for a refining process allowing a reduction or limitation of the quantity of peroxides in the oil submitted to hydroprocessing.

There is also a need for an alternative feedstock of biological origin to be used in a process for hydrotreating a mixture of a feedstock of petroleum origin and of a feedstock of biological origin

It has been discovered a process to use all kinds of natural mixtures of fatty acid esters and/or free fatty acids by applying hydrodynamic cavitation in order to protect the preheating equipment and the hydrotreating solid catalyst. In said process, fats and oils are refined to remove impurities contained in the mixtures of fatty acid esters and/or free fatty acids, in particular phosphorus, nitrogen, alkali or alkaline earth elements and metals either in the form of elements or contained in compounds.

As several sources of fats & oils arc not suitable to be converted in ester-type bio-diesel because they contain too much saturated acyl-moieties that result in high pour-points and hence improper cold-flow properties, while others are too unsaturated resulting in unstable products.

The present invention solves this problem by a process for the catalytic hydrotreating of a feedstock of petroleum origin of diesel fuel type introduced into a stationary bed hydrotreating unit upstream of a feedstock of natural occurring oil(s) characterized in that the feedstock of natural occurring oil(s) contains acyl-containing compounds having 10 to 24 carbons including fatty acid esters and some free fatty acids and said feedstock of natural occurring oil(s) is submitted to a refining before its introduction into the stationary bed, said treatment including a hydrodynamic cavitation processing in presence of water under conditions efficient to generate cavitation features and to transfer at least a part of impurities contained in the natural occurring Digs) into an aqueous phase, and separating the aqueous phase from an oil phase and recovering the oil phase as a refined oil.

In other words, the refined oil is defined as the feedstock of natural occurring oil(s) which is introduced into a stationary bed hydrotreating downstream of the feedstock of petroleum origin of diesel fuel type.

In particular, by applying hydrodynamic cavitation to the natural occurring oil(s), the invention allows removing essentially most of the impurities contained in the oil, in particular non-oil soluble components.

Impurities may include chemical elements that are detrimental to preheating equipment and solid catalysts, in particular hydrotreating catalysts, or compounds containing such chemical elements.

Examples of chemical elements detrimental to hydrotreating catalysts include phosphorous, silicon, alkali elements, alkaline earth elements, metals.

In particular, impurities removed may include phosphatides and metal-containing components to protect hydrotreating process using solid catalysts.

Advantageously, the hydrodynamic cavitation process may allow extracting hydratable and non-hydratable phosphatides, into the aqueous phase and hence producing separable gums.

Impurities to remove may also include nitrogen and chlorine, in form of chemical elemental or in the form of inorganic or organic compounds

Impurities to remove may also include peroxides.

In particular, when triglycerides are added in a diesel fuel feedstock, it is necessary to increase the amount of hydrogen H₂ supplied in order to cover an increased consumption of H₂ and to increase the temperature of the reaction, or the volume of catalyst, if it is desired to maintain the same hydrodesulphurization (HDS) activity, that is to say if it is desired to achieve the same level of sulphur at the outlet in comparison with a conventional HDS.

However, a higher reaction temperature results in a reduction in the duration of a cycle, so that it is preferable to be able to reduce this temperature in order to increase this duration. It is also preferable to limit the consumption of H₂ for economic reasons.

To this end, the invention provides a process for the catalytic hydrotreating of a feedstock of petroleum origin of diesel fuel type and, of a feedstock of natural occurring oil(s) containing acyl-containing compounds having 10 to 24 carbons including fatty acid esters and some free fatty acids refined by hydrodynamic cavitation in a stationary bed hydrotreating unit, in which the feedstock of petroleum origin is introduced into the said unit upstream of the feedstock of said natural occurring oil(s) refined by hydrodynamic cavitation.

Within the meaning of the present invention, the term “natural occurring oil(s) refined by hydrodynamic cavitation” is understood to mean any renewable feedstock commonly defined by the term “natural occurring oils) containing acyl-containing compounds having 10 to 24 carbons including fatty acid esters and some free fatty acids refined by hydrodynamic cavitation”, “feedstock of biological origin refined by hydrodynamic cavitation” or “vegetable oils and/or animal fats refined by hydrodynamic cavitation” or “natural occurring refined oil” or “biological refined oil” or “feedstock of natural occurring oil(s) refined”.

In the description “natural occurring oil(s)” designates indifferently oil, fat and their mixtures.

Specific examples of these fats & oils have been previously mentioned in the present specification.

Said natural occurring oil(s) may contain one or several oils chosen among vegetable oil, animal fat, preferentially inedible highly saturated oils, waste oils, by-products of the refining of vegetable oil(s) or of animal oil(s) containing free fatty acids, tall oils, and oil produced by bacteria, yeast, algae, prokaryotes or eukaryotes.

Due to its introduction upstream of the feedstock of natural occurring oil(s) containing acyl-containing compounds having 10 to 24 carbons including fatty acid esters and some free fatty acids refined by hydrodynamic cavitation, the treatment of the feedstock of petroleum origin is not disturbed by the treatment of the feedstock of biological origin refined by hydrodynamic cavitation. It is then possible to early out the reactions for hydrorefining the petroleum fraction under more favourable conditions in comparison with a joint introduction of the two types of feedstocks.

This is because the hydrodesulphurization of the feedstock of petroleum origin is not disturbed by the introduction of the feedstock of biological origin refined by hydrodynamic cavitation which takes place downstream. Thus, the hydrodeoxygenation of the feedstock of biological origin refined by hydrodynamic cavitation takes place downstream of the hydrodesulphurization of the petroleum fraction, so that the hydrodesulphurization can be carried out for the most part without the inhibiting effect of the CO and of the other gases formed during the reaction for the hydrodeoxygenating of the triglycerides of the feedstock of biological origin refined by hydrodynamic cavitation and so that the hydrogen partial pressure will, not be lowered by the reaction for the hydrorefining of the feedstock of biological origin, which makes it possible to maintain a high hydrodesulphurization catalytic activity.

The downstream introduction of the feedstock of biological origin refined by hydrodynamic cavitation also makes it possible to carry out the hydrodeoxygenating of the latter under more favourable conditions (lower hydrogen partial pressure, lower temperature and the like) which limit the formation of CH₄ and H₂O, which reduces the H₂ consumption and the exthermocity of the reaction.

This is because the cracking reactions which occur during the deoxygenation of the feedstock of biological origin refined by hydrodynamic cavitation (by decarbonylation and/or decarboxylation) result in the detachment of a carbon at the chain end, which will bring about a thermodynamic equilibrium between CO/CO₂/CH₄ by the CO shift reaction (CO+H₂O<->CO₂+H₂) and the reactions for the methanation of CO (CO+3H₂<->CH₄+H₂O) and of CO₂ (CO₂+4H₂<->CH₄+2H₂O).

Moreover, the CO/CO₂ ratio is always under the control of the equilibrium constant of the CO shift reaction.

Thus, a reduction in the concentration of CO, the inhibiting effect of which is a problem, in favour of the concentration of CO₂, which can be more easily removed, for example by washing with amines, is obtained by:
the decrease in the H₂ partial pressure, obtained according to the invention in that a large proportion of the hydrogen is consumed, by the hydrotreating of the diesel fuel feedstock upstream of the section for the hydrodeoxygenating of the feedstock of biological origin refined by hydrodynamic cavitation,
a shorter residence time of the feedstock of biological origin refined by hydrodynamic cavitation, obtained according to the invention in that it is possible to reduce the volume of catalyst downstream of the region for injection of the biological feedstock refined by hydrodynamic cavitation,
a treatment of the feedstock of biological origin refined by hydrodynamic cavitation at the lowest possible temperature, which can be obtained in an alternative form of the invention described later,
the addition of water, which can be obtained in another alternative form of the invention described later,
the removal of the carbon monoxide from the recycle gas of the unit, as described later.

Another advantage of the process according to the invention is the dilution of the feedstock of biological origin refined by hydrodynamic cavitation by the partially hydrotreated feedstock of petroleum origin resulting from the introduction of the feedstock of biological origin refined by hydrodynamic cavitation downstream of the feedstock of petroleum origin in the hydrotreating unit.

This is because the hydrotreating of the feedstocks of biological origin refined by hydrodynamic cavitation is highly exothermic and requires a means of control of the reaction temperature, such as the use of a large dilution volume. For this reason, to date, the feedstocks of biological origin refined by hydrodynamic cavitation were treated in dedicated units with high recycling of liquid effluent.

It is thus possible to limit, indeed even to eliminate, the recycling of liquid effluent by using the process according to the invention in comparison with the known processes for refining a feedstock of biological origin refined by hydrodynamic cavitation alone.

The process according to the invention also makes it possible:
to minimize the formation of methane (CH₄)
to improve the properties of the diesel fuel produced: cetane number, density, distillation, and the like,
to increase the volume of diesel fuel produced with the same feedstock of petroleum origin, which perfectly meets current requirements in Europe, where there is a lack of diesel fuel.

The process according to the invention furthermore makes it possible to use different catalysts in each of the catalytic regions where the feedstocks of petroleum and biological origin refined by hydrodynamic cavitation are injected: for example CoMo for the region for hydrorefining the petroleum fraction and preferably NiMo for the second region where the triglycerides are treated.

In a first alternative form of the process according to the invention, the hydrotreating unit is formed of a single reactor into which the feedstocks of petroleum and biological origin are injected.

This alternative form exhibits the advantage of making possible the use of an existing hydrotreating, unit to which will have been added an inlet for the feedstock of biological origin.

In a second alternative form, the hydrotreating unit is formed of two separate reactors, the feedstock of petroleum origin being injected into the first reactor and the feedstock of biological origin refined by hydrodynamic cavitation being injected into the second reactor as a mixture with the liquid effluent exiting from the first reactor.

This alternative form exhibits the advantage of making possible the treatment of the feedstock of biological origin refined by hydrodynamic cavitation at a lower temperature than the temperature for treatment of the feedstock of petroleum origin. This is because the hydrotreating of tit feedstock of biological origin refined by hydrodynamic cavitation can take place at a lower temperature so that it is not necessary to heat the feedstock a great detail in order to treat it. Moreover, most of the hydrotreating of the feedstock of petroleum origin has already taken place in the first reactor; the second reactor then makes possible the hydrofinishing of the treatment of the feedstock of petroleum origin and does not require temperatures which are so high. This hydrofinishing makes it possible to obtain a much lower sulphur content in comparison with the contents usually obtained in hydrorefining.

Moreover, generally, reactions for the recombination of olefins with H₂S, which are favoured at high temperature, are the cause of the formation of mercaptans and make it difficult to obtain diesel fuels with a very low sulphur content. In fact, treatment conditions at a lower reaction temperature in the second reactor are favourable to the minimizing of these recombination reactions, which makes it possible to obtain a product with a very low sulphur content (<3 ppm) or to reduce the harshness of the conditions in the first reactor for a given target for sulphur produced.

This lower temperature in the second reactor also makes it possible to improve the thermal stability of the feedstock of biological origin refined by hydrodynamic cavitation, in particular when the liquid effluent exiting from the first reactor is cooled prior to being mixed with the feedstock of biological origin refined by hydrodynamic cavitation. It is possible in particular to recover the heat from this effluent and to thus lower the temperature of the latter in order to heat the feedstock of petroleum origin, and if appropriate the feedstock of biological origin relined by hydrodynamic cavitation, before they enter their respective reactors.

The exothermicity of the reaction for hydrotreating, the feedstock of biological origin refined by hydrodynamic cavitation additionally requires a large dilution volume which is provided by the partially hydrotreated feedstock of petroleum origin exiting from the first reactor.

The lowering of the temperature of the second reactor also favours a reduction in the production of CO (see above).

Finally, to carry out the hydrodesulphurization reactions and the hydrodeoxygenating reactions in two separate reactors makes possible independent management of the catalysts in each of the reactors and makes possible the production of biomass-free diesel fuels. It is possible, for this, either to isolate the second reactor, in order to use only the first reactor, or to stop the feeding with vegetable oils and/or animal fats refined by hydrodynamic cavitation and use the two reactors for the hydrotreating of the diesel fuel feedstock.

In a third alternative form of the process according to the invention, the hydrotreating unit is formed of two separate reactors. The feedstock of petroleum origin is injected into the first reactor and the feedstock of biological origin refined by hydrodynamic cavitation is injected partly into the first reactor and partly into the second reactor, and the liquid effluent exiting from the first reactor is injected into the second reactor.

Advantageously, the space velocity (LHSV) of the feedstock of petroleum origin is less than the space velocity of the feedstock of biological origin refined by hydrodynamic cavitation, as a mixture with the effluent resulting from the treatment of the feedstock of petroleum origin.

Under the conditions of the process (P, T°), the formation of CH₄ and H₂O is thus slowed down because the reactions are limited kinetically (see the CO shift and methanation reactions described above). This results in a lower consumption of H₂ and in the production of a recycle gas which is more concentrated in hydrogen.

Advantageously, the feedstock of petroleum origin of diesel fuel type is chosen from the diesel fuel fractions originating from the distillation of a crude oil and/or of a synthetic crude resulting from the treatment of oil shales or of heavy and extra heavy crude oils or of the effluent from the Fischer-Tropsch process, the diesel fuel fractions resulting from various conversion processes, in particular those resulting from catalytic and/or thermal cracking (FCC, coking, visbreaking, and the like).

In particular, the feedstock of biological origin based on vegetable oils and/or animal fats refined by hydrodynamic cavitation is introduced up to a level of 15% by weight of the total feedstock (feedstock of petroleum origin and feedstock of biological origin).

More particularly, the level of feedstock of biological origin based on vegetable oils and/or animal fats refined by hydrodynamic cavitation is preferably less than or equal to 12% by weight. This is because the introduction of such a level of feedstock of biological origin refined by hydrodynamic cavitation only very slightly affects the low-temperature properties of the final product. In particular, the cloud point of the final effluent generally exhibits only a difference of 1′C with respect to the effluent obtained without injection of biomass. This result, which differs from that the laws of mixtures would have predicted, is highly advantageous as it demonstrates the synergy, during the process according to the invention, between the two types of feedstocks.

The introduction of high levels of feedstock of biological origin refined by hydrodynamic cavitation is made possible by virtue of the use of the hydrotreated feedstock of petroleum origin as diluent, without the need for recirculation of liquid effluent upstream of the introduction of the feedstock of biological origin.

According to a specific characteristic of the invention, use is made of an amount of hydrogen introduced into the first catalytic region of from 50 to 1000 Normal litres of H₂ per litre of feedstock of petroleum origin, preferably from 100 to 500 Normal litres of H₂ per litre of petroleum feedstock and more preferably still from 120 to 450 Normal litres of H₂ per litre of feedstock of petroleum origin.

The hydrogen coverage in the second catalytic region, according to a specific characteristic of the invention, is from HCl to 2000 Normal litres of H₂ per litre of total feedstock (feedstock of biological origin refined by hydrodynamic cavitation), as a mixture with the effluent resulting from the treatment of the feedstock of petroleum origin), preferably from 150 to 1500 Normal litres of H₂ per litre of total feedstock and more preferably still from 200 to 1000 Normal litres of H₂ per litre of total feedstock.

According to a specific characteristic of the invention, the temperature of the first catalytic region for treatment of the feedstock of petroleum origin is from 320 to 420° C., preferably from 340 to 400° C. According to another preferred characteristic of the invention, the temperature of the second catalytic region for treatment of the feedstock of biological origin refined by hydrodynamic cavitation, as a mixture with the effluent resulting from the treatment of the feedstock of petroleum origin, is from 250 to 420° C., preferably from 280 to 350° C.

According to a specific characteristic of the invention, the various feedstocks are treated at a pressure of 25 to 150 bar, preferably of 30 to 70 bar.

According to another characteristic of the invention, the LHSV of the feedstock of petroleum origin in the first catalytic region is from 0.3 to 5, preferably from 0.6 to 3 h⁻¹.

The LHSV in the second catalytic region of the total feedstock (feedstock of biological origin refined by hydrodynamic cavitation, as a mixture with the effluent resulting from the treatment of the feedstock of petroleum origin) is from 0.5 to 10, preferably from 1 to 5 h⁻¹.

Advantageously, according to the invention, the feedstock of petroleum origin is injected into a first catalytic region of the hydrotreating unit and the feedstock of biological origin refined by hydrodynamic cavitation is injected into a second catalytic region of the hydrotreating unit situated downstream of the first catalytic region.

It is thus possible to use specific catalysts in each catalytic region and to thus promote the hydrodesulphurization or hydrodeoxygenating reactions.

According to a specific characteristic of the invention, the feedstock of biological origin refined by hydrodynamic cavitation is ti treated over at least one catalytic bed in the hydrotreating unit, the catalytic bed comprising at least one catalyst based on metal oxides chosen from oxides of metals from Group VI-B (Mo, W, and the like) and VIII-B (Co, Ni, Pt, Pd, Ru, Rh, and the like) supported on a support chosen from alumina, silica/alumina, zeolite, ferrierite, phosphated alumina, phosphated silica/alumina, and the like. Preferably, the catalyst used will be NiMo, CoMo, NiW, PtPd or a mixture of two or more of these. The catalyst used can also be based on metals in the bulk state, such as the commercially known catalyst of Nebula type.

According to another specific characteristic of the invention, the feedstock of biological origin refined by hydrodynamic cavitation introduced into the hydrotreating unit is treated over at least one catalytic bed at least partially comprising a catalyst with an isomerizing role based on nickel oxides on an acidic support, such as amorphous silica/alumina, zeolite, ferrierite, phosphated alumina, phosphated silica/alumina, and the like.

Catalytic beds comprising NiW oxides exhibit the advantage of promoting isomerization reactions, which can make it possible to improve, that is to say to reduce, the cloud point of the finished product. In particular, in the case of a diesel fuel feedstock comprising a high cloud point, a catalytic bed comprising NiW, and preferably NiW oxides on amorphous silica/alumina, zeolite, ferrierite, phosphated alumina or phosphated silica/alumina, by promoting isomerization reactions, will make it possible to very markedly reduce the cloud point of the finished product.

Catalytic beds comprising catalysts of NiMo oxide type have a high hydrogenating and hydrodeoxygenating power for triglycerides.

Advantageously, the first catalytic region intended for the treatment of the feedstock of petroleum origin comprises one or more catalyst beds comprising catalysts which exhibit a good performance in hydrodesulphurization, while the second catalytic region intended for the treatment of the feedstock of biological origin refined by hydrodynamic cavitation comprises one or more catalyst beds comprising catalysts exhibiting a good performance for the deoxygenation of the triglycerides of the feedstock (for example based on NiMo) and/or catalysts promoting isomerization reactions. Preferably, in the final bed of the second catalytic region, use will be made of a catalyst with an isomerizing role which makes it possible to improve the low-temperature properties of the product. This catalyst can be composed of nickel oxides on an acidic support, such as amorphous silica/alumina, zeolite, ferrierite, phosphated alumina, phosphated silica/alumina, and the like. Preferably, NiW will be used.

Advantageously, water is injected into the hydrotreating unit in the region for treatment of the feedstock of biological origin refined by hydrodynamic cavitation. This injection of water makes it possible to shift the equilibrium of the CO shift reaction towards the conversion of CO to CO₂, which can be much more easily removed. The conversion to CO₂ and H₂ of the CO produced by the hydrodeoxygenation reaction is thus promoted, while limiting the methanation reaction which produces methane CH₄, which results in a decrease in the exothermicity and in the H₂ consumption.

In a particularly advantageous alternative form of the process comprising a treatment of recycle gas resulting from the hydrotreating of the total feedstock before it is reinjected into the hydrotreating unit, an additional treatment is carried out on the carbon monoxide present in the said recycle gas.

It is thus possible not to reinject carbon monoxide into the reactor in order not to risk inhibiting the catalyst.

In particular, such a treatment of the CO can be carried out when the CO content of the recycle gases reaches a predetermined value.

The separation and the treatment of the carbon monoxide can be carried out by the introduction, into the system for treating the recycle gases, of a device for the separation and treatment of carbon monoxide. In particular, it is possible to use CO conversion systems (referred to as CO shift systems by experts in this field), such as those generally supplied by hydrogen unit manufacturers. Thus, preferably, the carbon monoxide is treated by means of a CO conversion unit using the CO shift reaction. The CO is thus converted to CO₂, which can be more easily removed.

It is also possible to use a PSA (Pressure Swing Adsorption) treatment unit. This technology is known per se. The adsorbents are selected according to the nature of the impurities to be removed from the hydrogen-carrying streams, which are, in our case, carbon monoxide CO and optionally methane CH₄, ethane C₂H₆, propane C₃H₈, and the like.

Preferably, the gases thus separated are used in a steam reformer, such as a steam methane reformer (SMR). The CO and the other products from the deoxygenation of the feedstock of biological origin refined by hydrodynamic cavitation are thus enhanced in value as synthesis gas for the production of a hydrogen-comprising gas of biological origin refined by hydrodynamic cavitation. By using this configuration, the CO is thus enhanced in value and it is thus not necessary, in order to avoid its inhibiting effect, to reduce its concentration in favour of the concentration of CO₂ which can be more easily removed.

Advantageously, a treatment is additionally carried out during which the carbon dioxide (CO₂) and the hydrogen sulphide (H₂S) present in the said recycle gas are separated and treated before the reinjection of the recycle gas into the hydrotreating unit. This treatment is carried out, for example, by passing the recycle gas into an amine absorber. This additional treatment thus makes it possible to remove, from the circuit, the gases to be treated, that is to say CO₂ and H₂S.

Another particularly advantageous way of using the invention, here also as soon as the level of vegetable oils and animal fats refined by hydrodynamic cavitation is high, is to compensate for the exothermicity which necessarily results from the addition of these oils.

Thus, advantageously, the exothermicity of the hydrotreating of the feedstock is controlled by means of temperature control systems. In a conventional hydrotreating unit, these are, for example, the improvement in the liquid/gas distribution, gas and/or liquid quenches (that is to say, the supply of cold gases or liquids to the reactor), distribution of the catalyst volume over several catalytic beds, preheating control of the feedstock at the inlet of the reactor, in particular by action on the furnace and/or heat exchangers situated upstream of the reactor, on bypass lines, and the like, to lower the temperature at the inlet of the reactor.

According to a first alternative form of the invention, preference will be given to the addition of a liquid (liquid quench) to control the exothermicity.

This liquid can, for example, be composed of a portion of the hydrorefined feedstock exiting from the hydrorefining unit. It is introduced in the region for treating the feedstock of biological origin, refined by hydrodynamic cavitation, in particular when the hydrotreating unit comprises a single reactor.

When the hydrotreating, unit comprises two reactors, this liquid can be composed of a portion of the effluent from the first reactor. It is likewise introduced in the region for treatment of the feedstock of biological origin refined by hydrodynamic cavitation.

According to a second alternative form of the invention in which two separate reactors are used, a temperature control system consists in recovering the heat from the effluent exiting from the first reactor in order to lower its temperature before it is injected into the second reactor. This makes it possible to achieve a significant energy saving.

Advantageously, according to the invention, the hydrotreating unit operates as a single-pass unit, without recycling of liquid effluent at the top of the reactor.

The invention also relates to a hydrorefining unit comprising at least one catalytic hydrotreating unit as described hereafter, for the implementation of the said process.

Advantageously, the catalytic hydrotreating unit comprises at least one reactor provided with a first inlet for the introduction of a feedstock of petroleum origin of diesel fuel type and a second inlet for the introduction of a feedstock of biological origin based on vegetable and/or animal oils refined by hydrodynamic cavitation, the second inlet being situated downstream of the first inlet.

Advantageously, the catalytic hydrotreating unit comprises a first catalytic region intended for the treatment of the feedstock of petroleum origin and a second catalytic region situated downstream of the first catalytic region and intended for the treatment of the feedstock of biological origin refined by hydrodynamic cavitation diluted by the feedstock of petroleum origin exiting from the first catalytic region.

In a first embodiment, this catalytic hydrotreating unit comprises a single reactor.

In a second embodiment, the catalytic hydrotreating unit comprises two separate reactors, a first reactor provided with the said first inlet for the introduction of the feedstock of petroleum origin and a second reactor provided with the said second inlet for the introduction of the feedstock of biological origin refined by hydrodynamic cavitation, the said first reactor additionally comprising an outlet for the treated feedstock of petroleum origin, the said outlet joining the said second inlet of the second reactor.

In a third embodiment, the catalytic hydrotreating unit comprises two separate reactors, a first reactor provided with the said first inlet for the introduction of the feedstock of petroleum origin and with the said second inlet for the introduction of a portion of the feedstock of biological origin based on vegetable and/or animal oils refined by hydrodynamic cavitation, the second inlet being situated downstream of the first inlet, the said first reactor additionally comprising an outlet for the treated mixture of the two feedstocks, the said outlet joining the inlet of the second reactor, and the second reactor comprises a third inlet for the introduction of a portion of the feedstock of biological origin refined by hydrodynamic cavitation.

Preferably, the catalytic hydrotreating unit comprises at least one catalytic bed comprising at least one catalyst based on metal oxides chosen from oxides of metals from Group VI-B (Mo, W, and the like) and VIII-B (Co, Ni, Pt, Pd, Ru, Rh, and the like) supported on a support chosen from alumina, silica/alumina, zeolite, ferrierite, phosphated alumina, phosphated silica/alumina, and the like, preferably NiMo, CoMo, NiW, PtPd or a mixture of two or more of these.

Preferably, the catalytic hydrotreating, unit comprises at least one catalytic bed at least partially comprising a catalyst with an isomerizing role preferably based on nickel oxides on an acidic support, such as amorphous silica/alumina, zeolite, ferrierite, phosphated alumina, phosphated silica/alumina, and the like.

Preferably, the hydrorefining unit further comprises a separator which separates the liquid and vapour phases of the effluent exiting from the said hydrotreating unit and comprises, downstream of the separator, a unit for separation and treatment of the carbon monoxide (CO) present in the vapour phase of the effluent for the implementation of the process according to the invention.

Preferably, the hydrorefining comprises, downstream of the separator, a unit for separation and treatment of the carbon dioxide (CO₂) and hydrogen sulphide (H₂S) present in the vapour phase of the effluent for the implementation of the process according to the invention.

### DETAILED DESCRIPTION OF THE INVENTION

Natural Occurring Oil(S) Treated

The feedstock used in the process of the invention consists of natural occurring oil(s), in particular of a mixture of natural occurring oils.

A natural occurring oil is defined as an oil of biomass origin, and do not contain or consist of any mineral oil.

The natural occurring oil(s) can be selected among vegetable oils, animal fats, preferentially inedible highly saturated oils, waste oils, by-products of the refining of vegetable oil(s) or of animal oil(s) containing free fatly acids, tall oils, oils produced by bacteria, yeast, algae, prokaryotes or eukaryotes, and mixtures thereof.

In one embodiment, such natural occurring oil(s) may contain 50 w % or more of fatty acid esters and/or some free fatty acids, preferably 60 wt % or more, most preferably 70 wt % or more.

In one embodiment, such natural occurring oil(s) may contain fatty acids esters and some free fatty acids, containing one to three saturated or unsaturated (C₁₀-C₂₄) acyl-groups. When several acyl groups are present, they may be the same and different.

Suitable vegetable oils are for example palm oil, palm kernels oil, soy oils, soybean oil, rapeseed (colza or canals) oil, sunflower oil, linseed oil, rice bran oil, maize (corn) oil, olive oil, castor oil, sesame oil, pine oil, peanut oil, castor oil, mustard oil, palm kernel oil, hempseed oil, coconut oil, babasu oil, cottonseed oil, linola oil, jatropha oil, carinata oil.

Animal fats include tallow, lard, grease (yellow and brown grease), yellow and brown fish oil/fat, butterfat, milk fats.

The vegetable/animal oils (or fats) can be used crude, without any treatment after their recovery by any of the usual well known extraction methods, including chemical extraction (such as solvent extraction), supercritical fluid extraction, steam distillation and mechanical extraction (such as crushing).

By-products of the refining of vegetable oils or animal oils are by-products containing free fatty acids that are removed from the crude fats and oils by neutralisation or vacuum or steam distillation. Typical example is PFAD (palm free acid distillate).

Waste oils include waste cooking oils (waste food oil) and oils recovered from residual water, such as trap and drain greases/oils, gutter oils, sewage oils, for example from water purification plants.

Tall oils, including crude tall oils, distillate tall oils (DTO) and tall oil fatty acids (TOFA), preferably DTO and TOFA, can also be used in the present invention.

Tall oil, or otherwise known as tallol, is a liquid by-product of the Kraft process for processing wood, for isolating on the one hand the wood pulp useful in the papermaking industry, and on the other hand tall oil. Tall oil is essentially obtained when conifers are used in the Kraft process. After treating wood chips with sodium sulfide in aqueous solution, the tail oil isolated is alkaline. The latter is then acidified with sulfuric acid to produce crude tall oil.

Crude tall oil mainly comprises rosins (which contains resin acids, mainly cyclic abietic acid isomers), fatty acids (mainly palmitic acid, oleic acid and linoleic acid) and fatty alcohols, and unsaponifiable compounds in particular unsaponifiable sterols (5-10 wt %), sterols, and other hydrocarbons.

Insufficient acidification can lead to a crude tall oil containing metal salts, generally of sodium.

By fractional distillation of crude tall oil, tall oil fatty acids (TOFA) and distilled tall oil (DTO) can be recovered. DTO contains a mixture of fatty acids and resin acids and is a fraction heavier than TOFA fraction but lighter than tall oil pitch, which is the residue of the crude oil distillation. TOFA fraction consists mostly of C18 fatty acids. TOFA fraction may need to be purified to contain a rosin content to 1-10 wt %.

The natural occurring oil(s) used in the present invention also include oils produced by microorganisms, either natural or genetically modified microorganisms, such as bacteria, yeast, algae, prokaryotes or eukaryotes. In particular such oils can be recovered by mechanical or chemical extraction well known methods.

The above oils contain variable amounts of non-triglyceride components such as free fatty acids, mono and diglycerides, and many other organic and inorganic components including phosphatides, sterols, tocopherols, tocotrienols hydrocarbons, pigments (gossypol, chlorophyll), vitamins (carotenoids), sterols glucosides, glycolipids, protein fragments, traces of pesticides and traces metals, as well as resinous and mucilaginous materials.

Removal of some of these components, in particular components/chemical elements, which interfere with further processing and cause the oil, precipitate and poisoning hydrotreatment/hydroprocessing catalysts, is the objective of the refining step by hydrodynamic cavitation.

For the hydroprocessing of the present invention, essentially the phosphorous, alkali, alkaline earth, silicon and other metals as well as peroxides that might deteriorate the hydroprocessing step have to be removed. The deterioration might occur in the preheating section where the feedstock is brought to the reaction temperature where fouling of equipment can occur and hence require periodic cleaning. Deterioration might also occur where the active phase of the catalyst might lose catalytic activity or where pore plugging might occur by deposition of certain metals or metal oxides.

Refining Pretreatment

The refining step of the present invention includes a hydrodynamic cavitation processing in presence of water to remove impurities, in particular phosphorous, alkali, alkaline earth, silicon and other metals as well as peroxides that might deteriorate the hydroprocessing step, from the oil to treat. A refined oil is obtained at the end of the refining.

The hydrodynamic cavitational processing allows transferring impurities present in the oil to a water phase which is thereafter separated from the oil by commonly available separation methods.

In a preferred embodiment, the hydrodynamic cavitational processing is performed on the raw fats/oils, without previous pre-treatment (on crude oils).

It may also be envisaged to submit the raw crude fats/oils to a water degumming to remove the hydratable phosphatides and other metal-containing compounds, and then to submit the resulting oil to the hydrodynamic cavitation processing so as to remove efficiently the non-hydratable phosphatides and some remaining metal-containing compounds.

It may further be envisaged that two hydrodynamic cavitation processing steps are used: the first one with only water addition to remove essentially the hydratable phosphatides and other metal-containing compounds, followed by a hydrodynamic cavitation where a degumming agent are supplemented to the water to remove efficiently the non-hydratable phosphatides and some remaining metal-containing compounds.

Hydrodynamic Cavitation Processing

Cavitation is the phenomenon of formation of vapor bubbles into a flowing liquid in regions where pressure of liquid falls below its vapor pressure at the considered temperature.

Cavitation is a phenomenon of nucleation, growth and implosion (collapse) of vapor or gas filled cavities, which can be achieved by the passage of ultrasound (acoustic cavitation), by a laser, by injecting steam into a cold fluid or by alterations in the flow and pressure (hydrodynamic cavitation).

In the case of hydrodynamic cavitation, flow geometry is altered in such a way that the kinetic energy is increased by having a flow constriction which results into a considerable reduction in the local pressure of the liquid with a corresponding increase in the kinetic energy. When the pressure of the liquid falls below the vapor pressure of the same liquid, millions of vapor cavities are created, which are subjected to turbulent conditions of varying pressure fields downstream of the constriction, Life time of these cavities is very small (few micro seconds). The cavities finally collapse implosively and result in generation of very high pressures (up to 100 MPa) and temperatures (10,000 K), as well as intense shearing forces. The energy released upon implosion and/or pulsation of cavitation bubbles thus alters the property of the fluids and intensifies transport phenomenon and some chemical transformation.

It is well known that hydrodynamic cavitation occurs in all hydraulic systems in which considerable pressure differences occur, such as turbines, pumps and high-pressure nozzles.

The hydrodynamic cavitation processing of the present invention is performed under conditions efficient to generate cavitation features, in other words the formation and collapse of cavitation bubbles, which enhance the transfer of impurities (hydratable phosphatides and metal-containing compounds) contained in the oil into a water phase and which enhances the kinetics of certain reactions that transform non-hydratable phosphatides into hydratable phosphatides.

Those conditions depend on the properties of the fluid flow, the design of the cavitational device, the flow velocity, for example sustained by a pump, the temperature of the fluid flow and can be easily determined by the person skilled in the art. The cavitation phenomenon is categorized by the dimensionless cavitation number Cᵥ, which is defined as:

Cᵥ=(P−Pᵥ)/0.5ρV²,
where:
P [Pa] is the static pressure downstream of a restriction orifice,
Pᵥ [Pa] is the vapor pressure of fluid,
V [m/s] is an average velocity of fluid through the orifice, and
ρ [kg/ma] is the density of the fluid.

The cavitation, number at which cavitation begins is the cavitation inception number, Cᵥᵢ. Cavitation ideally begins at and a Cᵥᵢ<1 indicates a higher degree of cavitation. Cavitation may start at higher Cᵥᵢ when gases arc dissolved in the liquid, characterized by its Pᵥ. The quantity of cavitation events in a unit of flow is another parameter that can be considered. The effect of surface tension and size of cavities on the hydrostatic pressure is defined as follows: Pᵢ=P₀+2a/R, where Pᵢ is the hydrostatic pressure, a is the surface tension, and R is the radius of the bubble. The smaller the bubble, the greater the energy released during its implosion.

The cavitation processing is performed in presence of water.

The water amount should be enough to remove at least phosphatides and some metal-containing compounds. A proper amount of water is normally about 75 wt % of the phosphatides content of the oil.

In one embodiment, the water content is 1-5 wt % by volume of the oil volume, preferably 2-5 wt %.

The oil to treat may therefore be mixed with water prior to the cavitation processing if its water content is not sufficient.

The cavitation processing is maintained for a period of time sufficient to obtain the refined product.

Such hydrodynamic cavitation can be generated by passing the mixture to treat through one or several cavitation devices.

The hydrodynamic cavitation process may therefore include:
pumping the oil to treat through a cavitation device,
generating cavitation features to remove impurities.

Appropriate cavitation devices that can be used are for example disclosed in WO201098783A1, US8891180B2, US7762715B2, U.S. Pat. No. 8,042,989B2.

For example, a suitable cavitation device includes a flow-path through which the fluid is pumped, such as the one disclosed in US8911808B2, wherein a predetermined pump pressure is applied preferentially in the range of 340 kPa-34 MPA.

The cavitation temporarily separates the high-boiling ail constituents from the entrapped gases, water vapor and the vapors of the volatile impurities that can be found within the bubbles. The pulsation and/or implosion of these bubbles mixes the oil and water, greatly increasing the surface contact area of these unmixable liquids and enhancing the transfer of impurities to the water phase.

In the present case, using hydrodynamic cavitation processing allows modifying the hydratable and non-hydratable phosphatides and metals contained in the oil and transferring these impurities into an aqueous phase which can then be separated.

Without wishing to be bound by any theory, cavitation would also decompose peroxides to lead to products not yet identified, probably alcohols, dials and/or ketones, by mechanisms of reduction/rearrangement/hydration of the peroxides/accelerated oxidation by the peroxides of other carbons, therefore reducing the amount of peroxides in the refined oil and the risk of non-oil soluble gum forming in the subsequent intermediate storage, in subsequent preheating of the refined oil to the reaction.

In the present ease, using hydrodynamic cavitation processing allows to limit using of metal trap. The catalytic region for injection of the feedstock of biological origin comprises not necessary a first metal trap catalytic bed known per se. These metal traps are generally composed of macroporous alumina. The purpose of using such a commercially known metal trap is to free the vegetable oils and/or animal fats from the impurities which they might contain (Na, K, Cl and the like).

In the hydrodynamic cavitation processing, the phosphatides are hydrated to gums, which are insoluble in oil and can be readily separated as a sludge forming a water phase, for example by settling, filtering or centrifugal action.

The refining step of the present invention is therefore a degumming process.

As such, the refining can be improved by mixing the oil to treat with at least one degumming agent.

In an embodiment, the degumming agent can be chosen among water, steam, acids, complexing agents and their mixtures.

Acids are for example strong acids, in particular inorganic acids, such as phosphoric acid, sulphuric acid.

Complexing agents are for example weak organic acids (or their corresponding anhydrides) such as acetic acid, citric acid, oxalic acid, tartaric acid, malic acid, maleic acid, fumaric acid, aspartic amino acid, ethylenediaminetetraacetic acid (EDTA).

Preferably, the degumming agent comprises water, steam, phosphoric acid, acetic acid, citric acid, oxalic acid, tartaric acid, malic acid, fumaric acid, aspartic amino acid, ethylenediaminetetraacetic acid, alkali, salts, chelating agents, crown ethers, or maleic anhydride.

In an embodiment, the oil to treat may be mixed with water or a solution containing degumming agent(s).

In an embodiment, the oil to treat may be mixed with mineral-free water, distilled, de-ionized, soft water or similar type of water with no chemical agents added so as to improve the environmental impact, by reducing hazardous waste accumulation.

Water may be used alone without addition of other degumming agent. The treatment is then similar to the known water degumming treatment.

The addition of the degumming agent and or water can be performed before the cavitation processing (optional mixing step) or during the cavitation processing.

The oil to treat may also be mixed with a solvent such as hexane to improve flux or small amounts of soluble gases might be added in order to improve cavitation inception. Suitable gases are dihydrogen, dinitrogen, carbon dioxide, steam or mixtures thereof.

The oil to treat may also be mixed with a light hydrocarbons fraction or a gas stream to improve cavitation. Addition of such light hydrocarbons fraction/gas stream may further reduce viscosity of the feed treated in the hydrodynamic cavitational processing step and therefore reduce the pressure loss over the device, which may lower the vapor pressure, improve the creation of bubbles and therefore the cavitation.

In an embodiment, a light fraction comprising C4-C15 hydrocarbons, preferably C5-C10 hydrocarbons, may then be added to the natural occurring oil(s) in the hydrodynamic cavitational processing, for example prior to this step. Such light fraction comprises mainly, for example more than 90% wt or more than 95% wt, C4-C15 or C5-C10 hydrocarbons.

Such light fraction is for example a naphtha fraction, in particular a C5-C10 naphtha fraction, for example chosen among a naphtha fraction of mineral origin issued from the treatment of mineral oil, a naphtha fraction recovered from the fractionation of the effluent from the hydrocracking hydroisomerisation step (d) of the invention, or their mixture. Additional water, acids and/or complexing agents can be added to the light hydrocarbon fraction.

In an embodiment, a gas stream may be added to the natural occurring oil(s) in the hydrodynamic cavitational processing, for example prior to this step. The gas stream may comprise, or consist of, dihydrogen, carbon dioxide, dihydrogen sulfide, methane, ethane, propane or mixtures thereof.

Advantageously, the light fraction or the gas stream may represent from 0.1 to 10 wt % of the feed treated in the hydrodynamic cavitational processing step.

The pumping and cavitation generating steps may be repeated prior to performing the separating step. Alter natively, the pumping, cavitation generating and separating steps may be repeated using the separated oil phase.

Since hydrodynamic cavitation-assisted degumming provides vigorous mixing, it usually requires substantially smaller amounts of degumming agents than conventional methods. In addition, hydrodynamic cavitation-assisted degumming can be scaled up easily to accommodate large throughputs.

Often, cavitation-assisted degumming does not require extensive preheating of crude vegetable oil or water and, therefore, can be conducted at temperatures close to ambient or temperatures below the ambient, for example at 15-25° C. This protects unsaturated fatty acids from oxidation and deterioration and saves energy and feedstock.

However, the hydrodynamic cavitation can be carried out from 10 to 90° C., preferably from 25 to 75° C. and more preferably from 30 to 60° C.

Separation Step

The water phase can be separated by one or several of the following well known techniques: sedimentation, centrifugation, filtration, distillation, extraction or washing, preferably sedimentation, centrifugation, filtration. Optionally, after the hydrodynamic cavitation processing some neutralization agent might be added in order to mitigate corrosion issues or emulsification issues. The obtained refined oil can optionally be washed with water once again, followed by separation of the wash water and eventually drying of the refined oil.

Optional Pre-Treatment of the Refined Oil

In the present invention, the refined oil may still contain contaminants such as trace metals (alkali metals such as sodium and potassium), phosphorous (residual phosphatides), as well as solids, eventual oxidative degradation products, water and soaps.

This optional step can be performed in particular to further remove these impurities.

In an embodiment, this pre-treatment is a bleaching process.

Bleaching is a well known technique usually performed to decolour and purify chemically or physically refined oil. It usually ensures the removal of soaps, residual phosphatides, trace metals, and some oxidation products, and it catalyses the decomposition of carotene and the adsorbent also catalyses the decomposition of peroxides. Another function is the removal of the peroxides and secondary oxidation products.

Such process consists in contacting the refined oil with an absorbent, such as adsorptive clays, synthetic amorphous silica and activated carbons.

The key parameters for the bleaching process are procedure, adsorbent type and dosage, temperature, time, moisture and filtration, as shown in the Lipid Handbook (The lipid handbook, edited by Frank D. Gunstone, John L. Harwood, Albert J. Dijkstra. 3rd ed., chapter 3.7).

Another possible pre-treatment is an ion-exchange resin treatment. Such treatment involves contacting the refined oil with an ion-exchange resin in a pretreatment zone at pre-treatment conditions. The ion-exchange resin is for example an acidic ion exchange resin, such as Amberlyst™-15 and can be used as a bed in a reactor through which the feedstock is flowed, either upflow or downflow.

Another possible pre-treatment is a mild acid wash. Such treatment is carried out by contacting the refined oil with an acid such as Sulfuric, nitric, phosphoric, or hydrochloric in a reactor. The acid and refined oil can be contacted either in a batch or continuous process. Contacting is done with a dilute acid solution usually at ambient temperature and atmospheric pressure. If the contacting is done in a continuous manner, it is usually done in a counter current manner.

Yet another possible pre-treatment is the use of guard beds which are well known in the art. These can include alumina-containing guard beds either with or without demetallization catalysts such as nickel, cobalt and/or molybdenum.

Filtration and solvent extraction techniques are other choices which may be employed.

In a preferred embodiment, a bleaching process is used.

The invention is now described with reference to the appended nonlimiting drawings, in which:

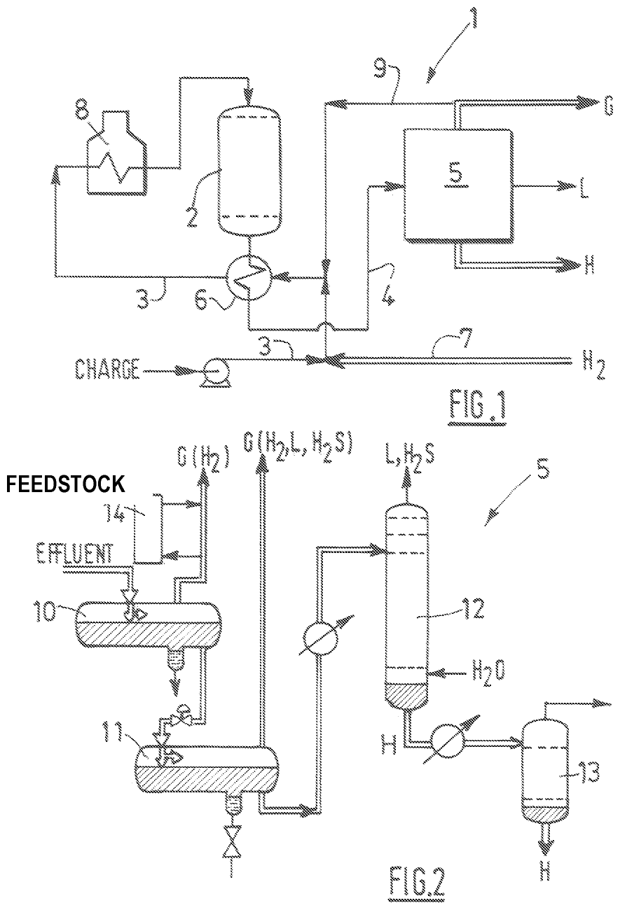

FIG. 1 is a simplified diagram of a unit 1 for the conventional hydrorefining of a feedstock of diesel fuel type;

FIG. 2 is a simplified diagram of a separation section of a conventional hydrorefining unit;

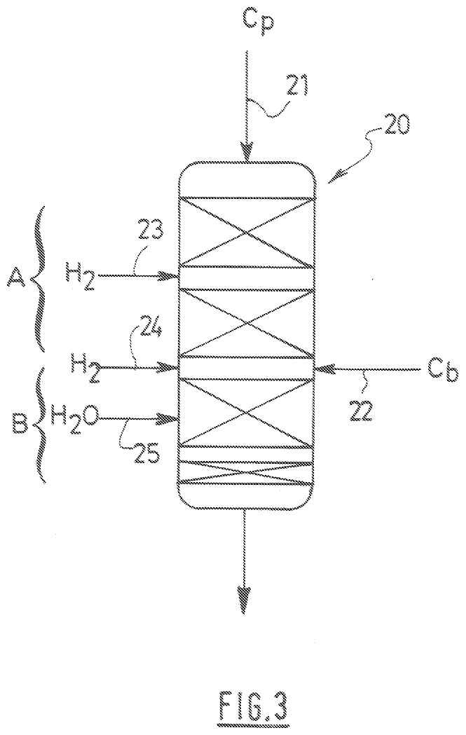

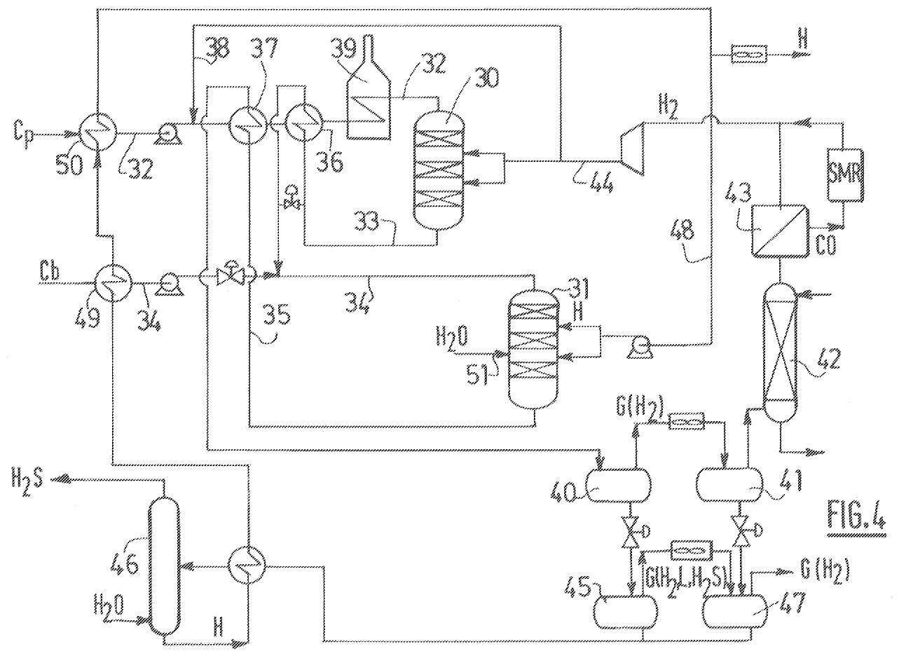

FIG. 3 is a simplified diagram of a hydrotreating unit according to a first embodiment of the invention comprising a single reactor;

FIG. 4 is a simplified diagram of a hydrorefining unit comprising a hydrotreating unit according to a second embodiment of the invention comprising two reactors.

FIG. 5 represents table 1

FIG. 1 represents a simplified diagram of a unit 1 for the conventional hydrorefining of a feedstock of diesel fuel type. This unit 1 comprises a reactor 2 into which the feedstock to be treated is introduced by means of a line 3. This reactor comprises one or more hydrorefining catalyst beds.

A line 4 recovers the effluent at the outlet of the reactor 2 and conveys it to a separation section 5.

A heat exchanger 6 is placed downstream of the reactor on the line 4 in order to heat the feedstock moving in the line 3 upstream of the reactor.

Upstream of this heat exchanger 6, a line 7, connected to the line 3, supplies an H₂-rich gas to the feedstock to be treated.

Downstream of the heat exchanger 6 and upstream of the reactor 2, the feedstock mixed with the H₂-rich gas moving in the line 3 is heated by a furnace 8.

Thus, the feedstock is mixed with the hydrogen-rich gas and then brought to the reaction temperature by the heat exchanger 6 and the furnace 8 before it enters the reactor 2. It subsequently passes into the reactor 2, in the vapour state if it is a light fraction and as a liquid/vapour mixture if it is a heavy fraction.

At the outlet of the reactor, the mixture obtained is cooled and then separated in the separation section b, which makes it possible to obtain:
an H₂S-rich sour gas G, a portion of which is reinjected into the H₂-rich gas mixed with the feedstock by means of a line 9,
light products L which result from the decomposition of the impurities. This is because the removal of sulphur, nitrogen, and the like, results in the destruction of numerous molecules and in the production of lighter fractions,
a hydrorefined product H with a volatility similar to that of the feedstock but with improved characteristics.

Conventionally, the effluent exiting from the reactor 2 is cooled and partially condensed and then enters the separation section 5.

Such a separation section 5 generally comprises (FIG. 2):
a first high-pressure knockout vessel 10 which makes it possible to separate a hydrogen-rich gas G(H₂) from the effluent, it being possible for this gas to be recycled,
a second low-pressure (10 bar) knockout vessel 11 which separates the liquid and vapour phases obtained by reducing in pressure the liquid originating from the high-pressure knockout vessel 10. The gas G(H₂, L, H₂S) obtained comprises mainly hydrogen, light hydrocarbons and a large part of the hydrogen sulphide formed in the reactor,
a stripper 12, the role of which is to remove the residual and light hydrocarbons L from the treated feedstock. The hydrorefined product H is withdrawn at the base of this stripper,

a dryer 13, which makes it possible to remove the water dissolved by the hot hydrorefined product in the stripper.

According to a first embodiment, a catalytic hydrotreating unit according to the invention is formed of a single reactor 20, as represented in FIG. 3. This reactor 20 is provided with a first inlet 21 for the introduction of a feedstock of petroleum origin (ep) of diesel fuel type and a second inlet 22 for the introduction of a feedstock of biological origin (Cb) refined by hydrodynamic cavitation, the second inlet 22 being situated downstream of the first inlet 21.

Preferably, the inlet 21 for the feedstock of petroleum origin is conventionally situated at the top of the reactor.

The reactor 20 comprises several catalytic beds which are divided into two catalytic regions: a first region situated upstream of the second inlet 22, intended for the treatment of the feedstock of petroleum origin, and a second region B situated downstream of this second inlet 22, intended for the treatment of the feedstock of biological origin refined by hydrodynamic cavitation.

The first catalytic region A will preferably comprise a catalyst which promotes the hydrodesulphurization of the feedstock of petroleum origin.

The second catalytic region B will preferably comprise a catalyst which promotes the deoxygenation of the feedstock of biological origin refined by hydrodynamic cavitation. Advantageously, this region B comprises at least one first bed comprising an NiMo-based catalyst and a final bed comprising a catalyst with an isomerizing role which makes it possible to improve the low-temperature properties of the product.

Furthermore, the reactor 20 comprises an inlet 23 for the introduction of hydrogen 142 in the first catalytic region A and preferably a second inlet 24 for introduction of hydrogen H₂ in the second catalytic region B, these injections of 112 acting as gaseous quench.

Finally, it is possible to allow an inlet 25 for the introduction of water in the catalytic region B, this injection B making it possible to promote the conversion to CO₂ of the CO which may have been formed.

The reactor forming the catalytic hydrotreating unit 20 according to the invention can be used in a conventional hydrorefining unit such as that described with reference to FIG. 1, as replacement for the reactor 2 of this unit.

According to a second embodiment, a catalytic hydrotreating unit according to the invention is formed of two reactors 30, 31. FIG. 4 represents a hydrorefining unit equipped with such a catalytic hydrotreating unit.

The diagram of this hydrorefining unit is very similar to that of the unit represented in FIG. 1.

The first reactor 30 of the catalytic hydrotreating unit according to the invention is preferably identical to the reactor 2 of FIG. 1. The feedstock of petroleum origin Cp is conveyed to the top of this reactor by means of a line 32 but the liquid effluent exiting from this first reactor, instead of being directed to a separation section, is sent to the top of the second reactor 31 by means of a line 33.

A line 34 conveying the feedstock of biological origin refined by hydrodynamic cavitation Cb joins the line 33 before it enters the top of the second reactor 31.

A line 35 recovers the liquid effluent at the outlet of the second reactor 31 and conveys it to a separation section.

Just as for a conventional unit, a heat exchanger 36 is placed downstream of the first reactor 30 on the line 33 in order to heat the feedstock Cp moving in the line 32 upstream of the first reactor 30.

Preferably, the hydrorefining unit according to the invention additionally comprises a second heat exchanger 37 placed downstream of the second reactor 31 on the line 35 which also heats the feedstock Cp moving upstream of the first reactor 30, this second exchanger 37 being, for example, placed upstream of the first exchanger 36.

Upstream of these heat exchangers 36 and 37, a line 38 connected to the line 32 supplies an H₂-rich gas to the feedstock Cp to be treated.

Downstream of the heat exchangers 36, 37 and upstream of the first reactor 30, the feedstock of petroleum origin mixed with the H₂-rich gas moving in the line 32 is heated by a furnace 39.

The liquid effluent is cooled at the outlet of the second reactor 31 and then separated in a separation section which comprises a first, high-pressure “hot” knockout vessel 40 which makes it possible to separate, horn the effluent, a hydrogen-rich gas G(H₂) also comprising CO and CO₂. This gas G(H₂) is conveyed to another low-pressure “cold” knockout vessel 41, then conveyed to a unit 42 for the treatment and separation of CO₂, for example an amine absorber, and then to a unit 43 for the separation and treatment of CO of the PSA type. The CO separated in this unit 43, as well as the other gases separated, such as CH₄, C₂H₆, C₃H₈, and the like, can advantageously be sent to an SMR unit for the production of hydrogen H₂. This hydrogen can then optionally be returned in the line 44 bringing back the recycle gas to the first reactor 30 as gaseous quench and in the line 38 for the treatment of the feedstock Cp.

The liquid effluent exiting from the first knockout vessel 40 is, for its part, directed to another low-pressure (10 bar) knockout vessel 45 which separates the liquid and vapour phases obtained by reducing in pressure the liquid originating from the high-pressure knockout vessel 40, The gas G(H₂, L, H₂S) obtained comprises mainly hydrogen, light hydrocarbons and a large part of the hydrogen sulphide formed in the reactor. The liquid effluent resulting from this knockout vessel 45 is conveyed to a steam stripper 46, the role of which is to remove the residual H₂S and light hydrocarbons from the treated feedstock. The gaseous effluent exiting from the knockout vessel 45 can be sent to another knockout vessel 47 fed with the liquid effluent exiting from the knockout vessel 41, the liquid effluent of which is also conveyed to the stripper 46. The gas exiting from this knockout vessel 47 can be made use of.

The hydrorefined product H is withdrawn at the base of this stripper 46.

The separation unit described above and composed of the knockout vessels 40, 41, 45 and 47, of the stripper 46 and of the treatment units 42, 43 can, of course, be used at the outlet of the single reactor described in FIG. 3. Depending on the conditions, it is also possible to allow only two successive knockout vessels 40 and 41, the liquid effluents of which are directed directly to the stripper 46.

A portion of the hydrorefined product H can be introduced into the second reactor via a line 48 in order to act as liquid quench. Heat exchangers 49, 50, respectively placed on the lines 34 and 32, can be used for the preheating of the feedstock of biological origin refined by hydrodynamic cavitation and of the feedstock of petroleum origin respectively.

The hydrorefined product H may be further fractionated into LPG, naphtha, Jet fuel and diesel fractions. The naphtha fraction may be partly recycled to be refined by hydrodynamic cavitation with the feedstock of biological origin. Alternatively, a naphtha fraction from another unit may be refined by hydrodynamic cavitation with the feedstock of biological origin.

Just as in the preceding embodiment with one reactor, it is possible to allow for injection of water 51 into the second reactor 31.

This unit thus makes it possible to carry out the hydrorefining of petroleum fractions in the first reactor 30 and to finish the hydrorefining of the petroleum fractions in the second reactor 31, and also to deoxygenate the triglycerides of the feedstock of biological origin refined by hydrodynamic cavitation.

In addition, it is clearly apparent that the second reactor can be easily isolated from the circuit by means of valves, a bypass line directly conveying the liquid effluent exiting from the first reactor to the separation and treatment devices. Thus, this hydrorefining unit can be used for the hydrotreating of a feedstock of petroleum origin, with or without addition of a feedstock of biological origin refined by hydrodynamic cavitation.

The following examples illustrate the advantages produced by the process according to the invention.

### EXAMPLES

Examples 1-4 have been performed using a laboratory hydrodynamic cavitation device fabricated by installing a Venturi tube in a hydrodynamic cavitation setup equipped with a pump at the inlet and a pressure controller at the outlet. The Venturi tube has an orifice opening (throat diameter) of 0.75 mm and an orifice length (throat length) of 1 mm, a wall of 25° inclination (related to the flow axe) at the inlet (convergent section) and a wall of 6° inclination (related to the flow axe) at the outlet (divergent section). The pipes to the Venturi convergent and divergent sections have a diameter of 5 mm and a length of 50 mm.

The phosphorus content of raw rapeseed and hydrodynamic cavitation processed product has been measured by means of ICP (Inductive Coupled Plasma).

### Ex. 1

Raw rapeseed oil (10 kg) was mixed with 2 wt % water, well mixed and pressure increased with, the aid of the pump in order to have a ratio outlet pressure to inlet pressure of less than 0.75. At an outlet pressure of 2 bars the mixture rapeseed, oil and water was passed through the hydrodynamic cavitation device at 40° C. While the raw rapeseed oil had a phosphorus content of 811 wppm the rapeseed product after cavitation treatment and separation of the aqueous phase by centrifugation, has a phosphorus content of 26 wppm.

### Ex. 2

The raw rapeseed oil (10 kg) was mixed with 2 wt % of a water solution containing 10 wt % of citric acid 0.2 wt % citric acid on oil basis) and stirred vigorously for 30 minutes. The pressure was increased with the aid of the pump in order to have a ratio outlet pressure to inlet pressure of less than 0.75. At an outlet pressure of 2 bars the mixture rapeseed oil and water was passed through the hydrodynamic cavitation device at 40° C. While the raw rapeseed oil had a phosphorus content of 811 wppm the rapeseed product after cavitation treatment and separation of the aqueous phase by centrifugation, has a phosphorus content of 1 wppm.

### Comparative Ex. 3

Raw rapeseed oil (10 kg) was mixed, with 2 wt % water, well mixed and heated to 65° C. during 30 minutes in a lab vessel at a stirring speed of 500 rpm. The aqueous phase was separated by centrifugation. The phosphorus content has dropped from 811 wppm to 120 wppm.

### Comparative Ex. 4

Raw rapeseed oil (10 kg) was mixed with 2 wt % of a water solution containing 10 wt % of citric acid (0.2 wt % citric acid on oil basis), well mixed and heated to 65° C. during 30 minutes in a lab vessel at a stirring speed of 500 rpm. The aqueous phase was separated by centrifugation. The phosphorus content has dropped from 811 wppm to 51 wppm.

### Ex. 5

In a small pilot unit, a nickel-molybdenum on alumina catalyst was loaded and presulphurised with DMDS/SRGO mixture under dihydrogen. The product of example 2, having only 1 wppm of remaining phosphorus was processed in order to deoxygenate the triglycerides at about 275° C. and 80 barg (hydrogen to liquid ratio of 900 N1/1). The LHSV was 1 h−1. Nearly full deoxygenation could be reached during more than 1000 hours on stream without any deactivation nor plugging of the pilot unit.

### Comparison Ex. 6

In the same small pilot unit, the product of example 4, having still 51 wppm of remaining phosphorus was processed in order to deoxygenate the triglycerides at about 275° C. and 80 barg (hydrogen to liquid ratio of 900 N1/1). The LHSV was 1 h−1. Nearly full deoxygenation could be reached during only 20 hours on stream after which plugging of the pilot unit started with increase of inlet pressure. Semi-quantitative analysis (about 10% error) by means of XRF (X-ray fluorescence spectroscopy) showed that the material constituting the plug was significantly enriched in phosphorus (more than 2000 wppm) compared to only 51 wppm in the feedstock.

1.-15. (canceled)

16. A process for catalytic hydrotreating comprising:
introducing a feedstock of petroleum origin of diesel fuel type into a stationary bed hydrotreating unit upstream of a feedstock of natural occurring oil(s), wherein the feedstock of natural occurring oil(s) contains acyl-containing compounds having 10 to 24 carbons including fatty acid esters and free fatty acids;
refining the feedstock of natural occurring oil(s) before its introduction into the stationary bed, wherein the refining comprises a hydrodynamic cavitation processing in the presence of water under conditions efficient to generate cavitation features and to transfer at least a part of impurities contained in the natural occurring oil(s) into an aqueous phase, and separating the aqueous phase from an oil phase and recovering the oil phase as a refined oil; and
pre-treating the refined oil to further remove impurities and to obtain a pre-treated oil.

17. The process according to claim 16, characterised in that the pre-treatment performed is chosen among a bleaching process in which the refined oil is contacted with an absorbent, a process in which the refined oil is contacted with an ion-exchange resin, a mild acid wash of the refined oil, a process using guard-beds, filtration, solvent extraction.

18. The process according to claim 16 wherein the natural occurring oil(s) contain(s) one or several oils chosen among vegetable oil, animal fat, waste food oils, by-products of the refining of vegetable oil(s) or of animal oil(s) containing free fatty acids, tall oils, and oil from produced by bacteria, yeast, algae, prokaryotes or eukaryiotes.

19. The process according to claim 16, characterised in that at least one degumming agent is added to the natural occurring oil(s) in the hydrodynamic cavitation processing.

20. The process according to claim 20, characterized in that the degumming agent is chosen from among water, steam, acids and complexing agents.

21. The process according to claim 16, characterized in that the feedstock of petroleum origin is injected into a first catalytic region of the hydrotreating unit and in that the feedstock of natural occurring oil(s) refined is injected into a second catalytic region of the hydrotreating unit situated downstream of the first catalytic region.

22. The process according to claim 16, characterized in that the hydrotreating unit is formed of a single reactor into which the feedstocks of petroleum and the feedstock of natural occurring oil(s) refined are injected.

23. The process according to claim 16, characterized in that the hydrotreating unit is formed of two separate reactors and in that the feedstock of petroleum origin is injected into the first reactor and the the feedstock of natural occurring oil(s) refined is injected into the second reactor as a mixture with the liquid effluent exiting from the first reactor.

24. The process according to claim 16, characterized in that the space velocity (LHSV) of the feedstock of petroleum origin is less than the space velocity of the the feedstock of natural occurring oil(s) refined, as a mixture with the effluent resulting from the treatment of the feedstock of petroleum origin.

25. The process according to claim 16, in which the feedstock of petroleum origin of diesel fuel type is chosen from the diesel fuel fractions originating from the distillation of a crude oil and/or of a synthetic crude resulting from the treatment of oil shales or of heavy and extra heavy crude oils or of the effluent from the Fischer-Tropsch process, the diesel fuel fractions resulting from various conversion processes, in particular those resulting from catalytic and/or thermal cracking (FCC, coking, visbreaking, and the like).

26. The process according to claim 16, in which the level of the feedstock of natural occurring oil(s) refined is up to 15% by weight with respect to the feedstock of petroleum origin and the feedstock of natural occurring oil(s).

27. The process according to claim 16, in which a light fraction comprising C4-C15 hydrocarbons, is added to the natural occurring oil(s) in the hydrodynamic cavitation processing step.

28. The process according to claim 16, characterised in that a gas stream comprising dihydrogen, carbondioxide, dihydrogensulfide, methane, ethane, propane or mixtures thereof, is added to the natural occurring oil(s) in the hydrodynamic cavitation processing step.

29. The process according to claim 16, in which the light fraction is a naphtha fraction, optionally recovered from the fractionation of the effluent of the hydrotreating process.
